(19) United States
(12) Patent Application Publication
(10) Pub. No.: US 2024/0086766 A1
(43) Pub. Date: Mar. 14, 2024

(54) CANDIDATE MACHINE LEARNING MODEL IDENTIFICATION AND SELECTION

(71) Applicant: Telefonaktiebolaget LM Ericsson (publ), Stockholm (SE)

(72) Inventors: Athanasios KARAPENTELAKIS, Solna (SE); Alessandro PREVITI, Stockholm (SE); Konstantinos VANDIKAS, Solna (SE); Lackis ELEFTHERIADIS, Valbo (SE); Marin ORLIC, Bromma (SE); Marios DAOUTIS, Bromma (SE); Maxim TESLENKO, Sollentuna (SE); Sai Hareesh ANAMANDRA, Bangalore (IN)

(21) Appl. No.: 18/274,262

(22) PCT Filed: Jan. 29, 2021
(86) PCT No.: PCT/EP2021/052177

§ 371 Date: Jul. 26, 2023

(51) Int. Cl. G06N 20/00; H04L 41/16

(52) U.S. Cl. CPC G06N 20/00; H04L 41/16

(57) ABSTRACT

A computer-implemented method performed by a network node is provided. The method includes receiving a request for retrieving or executing a machine learning (ML) model or a combination of ML models. The request includes a first description of a specified output feature and specified input data type and distribution of input values for a ML model or combination of ML models. The method further includes obtaining an identification of a ML model, or a combination of ML models, having a second description that at least partially satisfies a match to the first description; identifying a candidate ML model, or combination of ML models, that produces the specified output feature of the first description based on a comparison of the first and second descriptions. The method further includes selecting a third description of the identified candidate ML model, or combination of ML models, based on a convergence.

### TECHNICAL FIELD

The present disclosure relates generally to methods for identification and selection of at least one candidate machine learning model, and related methods and apparatuses.

### BACKGROUND

Machine Learning (ML) models are trained to serve a specific function, and a large repository of already trained ML models currently exist online.

In ML, a ML model is a series of operations that transforms an input to an output. These operations are biased and contain coefficients (also known as weights), which, depending on their value produce different output given an input. The value for weights can be determined after training of a ML model, using a sufficiently large and diverse number of <input, output> data pairs in what is known as a “dataset”. Current practice includes approaches where the ML models are domain specific, meaning that they target specific areas or applications. For example, already trained ML models exist for computer vision (e.g., detecting objects in images/video frames), automatic speech recognition (ASR), text classification, text generation (e.g., the namignizer model for producing names), natural language processing, robot navigation/planning etc. E.g., https://aws.amazon.com/marketplace/b/6297422012?ref=hmpg categories 62974220 12 (accessed Jan. 21, 2021). With current computational capacity and ML model architectures (e.g., Deep Neural Networks), it is not possible to have a model for general-purpose ML.

### SUMMARY

A large repository of already trained ML models are currently online. While it may be beneficial to combine ML models of different architectures but having the same inputs and outputs to have a generally applicable ML model, current approaches (e.g., ensembling or reasoning-based approaches) are deficient as such approaches are by design, rather than on demand, need training, and/or need preexisting knowledge. Various embodiments of the present disclosure include a method for choosing ML models from a repository given a request from a data providing entity that includes a description of input data types as well as a description of a specified output; and combining these ML models in such a way so that from the description, the specified output is obtained. Potential advantages of various embodiments of the present disclosure may include universal or general applicability of the disclosed method on demand and without needing training and/or preexisting knowledge. As a consequence, the method may be immediately applied to existing repositories of ML models.

In various embodiments, a computer-implemented method performed by a network node in a communication network is provided. The method includes receiving, from a data provider entity, a request for retrieving or executing a ML model or a combination of a plurality of ML models. The request includes a first description of at least one specified output feature and a specified input data type and distribution of input values for the ML model or the combination of a plurality of ML models. The method further includes obtaining, from a repository containing a plurality of ML models each having a second description of at least one specified output feature and input data type, an identification of at least one ML model or at least one combination of a plurality of ML models having a second description that at least partially satisfies a match to the first description. The method further includes identifying at least one candidate ML model from the plurality of ML models based on (1) a first comparison of the second description of each of the plurality of ML models to the first description to obtain a first identity of any subset of the plurality of ML models having a second description that matches the first description, and (2) a second comparison of the second description to each of the remaining of the plurality of ML models, other than the subset, to obtain a second identity of at least one ML model that, or at least one combination of ML models from the remaining ML models that when combined, produce the at least one specified output of the first description. The method further includes selecting a third description of the identified at least one candidate ML model based on a convergence of the first identity and the second identity.

In some embodiments, the method further includes requesting a full set of the specified input data from the data provider entity. The method further includes receiving the full set of the specified input data from the data provider entity. The method further includes verifying the identified at least one candidate ML model against the full set of the specified input data from the data provider entity.

In some embodiments, subsequent to the verifying, the method further includes choosing the identified at least one candidate ML model based on the greatest accuracy or on training the identified at least one candidate ML model with a subset of the full set of the specified input data. The method further includes sending the identified at least one candidate ML model, or a token for execution of the identified at least one candidate ML model, to the data processing entity.

In some embodiments, the method further includes sending the selected third description of the identified at least one candidate ML model to the data processing entity.

In other embodiments, a computer-implemented method performed by a data processing entity in a communication network is provided. The method includes sending, to a network node, a request for retrieving or executing a ML model or a combination of a plurality of ML models. The request includes a first description of at least one specified output feature and a specified input data type and distribution of input values for the ML model or the combination of a plurality of ML models.

In some embodiments, the method further includes receiving a request from the network node for a full set of the specified input data. The method further includes sending, to the network node, the full set of the specified input data from the data provider entity. The method further includes receiving, from the network node, an identified at least one candidate ML model or a token for execution of the identified at least one candidate ML model.

In some embodiments, the method further includes, responsive to the request, receiving from the network node the identified at least one candidate ML model or a description of the identified at least one candidate ML model. The method further includes verifying the identified at least one candidate ML model.

Corresponding embodiments of inventive concepts for a network node, a data processing entity, computer program products, and computer programs are also provided.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a drawing of the human brain illustrating collaborating neural networks to interpret speech and respond;

FIG. 2 is a sequence flow illustrating a method for combining ML models in accordance with various embodiments of the present disclosure;

FIG. 3 is a block diagram illustrating an example embodiment of three ML models combined in accordance with various embodiment of the present disclosure;

FIG. 4 is a block diagram of a network node in accordance with some embodiments of the present disclosure;

FIG. 5 is a block diagram of a data processing entity in accordance with some embodiments of the present disclosure;

FIG. 6 is a block diagram of a repository in accordance with some embodiments of the present disclosure;

FIGS. 7 and 8 are flow charts of operations of a network node according to various embodiments of the present disclosure; and

FIGS. 9 and 10 are flow charts of operations of a data processing entity in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

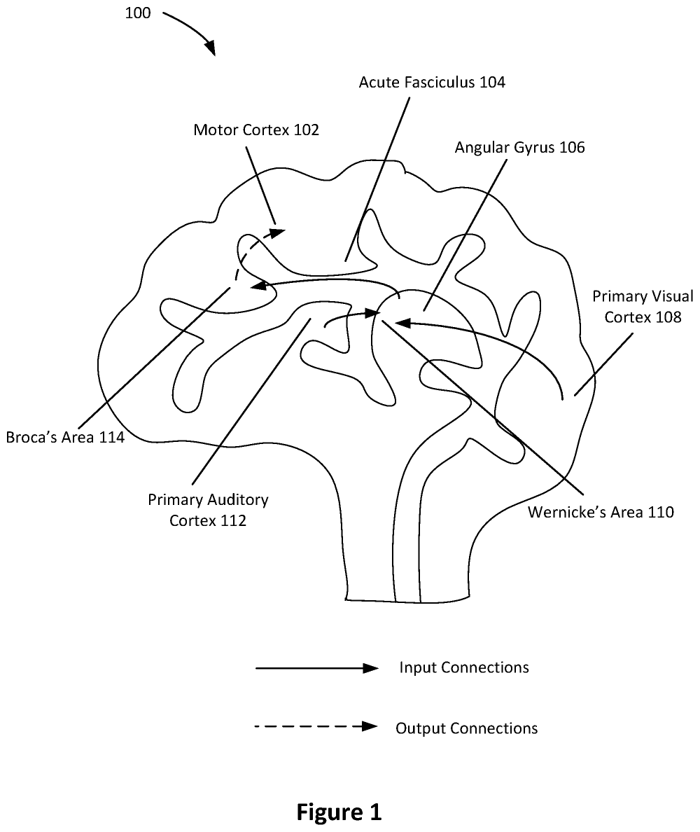

A model for a general-purpose ML may be desirable. A general ML model may involve multiple single-purpose neural networks and may be explained by reviewing the way the human brain works. FIG. 1 is a drawing of the human brain illustrating collaborating neural networks to interpret speech and respond. As illustrated in FIG. 1, the human brain 100 works using collaborating neural networks, where the output of one neural network is input to the next. FIG. 1 illustrates which networks are involved when a human engages in a discussion with another person. Specifically, auditory cortex 112 and visual cortex 108 capture audio and pictures using ears and eyes as sensors. Subsequently, Wernicke's area 110 is used for speech recognition and comprehension, while Broca's area 114 is used for speech synthesis. The motor cortex 102 plans and executes movements (e.g., mouth, hands, posture, etc.).

For non-biological neural networks, a large collection of neural networks is available. However, they do not function as an integrated system, as the output/input features do not exactly match.

The following explanation of potential problems with some approaches is a present realization as part of the present disclosure and is not to be construed as previously known by others.

It may be beneficial to combine ML models of different architecture but of the same input and output, as this may lead to a greater generalization over a task at hand. Chaining of ML models in a pipeline may also lead to more generic inferences, compounding value of individual ML models as discussed further herein.

In some approaches, model ensembling techniques such as boosting, and bagging involve manual association of different ML models. Such associations may effectively enable ML models to be combined in various ways thus achieving improved performance as opposed to using each ML model in isolation. In an example of a bagging technique, weighted averaging may be used and can be adjusted dynamically over time to favor certain ML models as opposed to others.

Reasoning has been proposed as an approach to stack ML models by associating their inputs or the output of each ML model semantically with the input of another ML model, respectively. However, such an approach is also achieved by design rather than on demand, as it assumes the presence of a knowledge base that holds all these associations for one or more domains. In the case that such an ontology exists, the input features may only match those mentioned in the ontology in the description but not when it comes to their actual content.

Another challenge with ensembling may be that it can be non-obvious how to combine ML models. As a consequence, ensembling may typically be achieved by design instead of opting for on-demand dynamic mechanisms that build that association. This means that association rules between ML models exist a priori. For example, with bagging (also known as bootstrap aggregating), output of a number of ML models may be averaged per output feature.

Reasoning-based approaches are also achieved by design, rather than on demand, as they assume the presence of a knowledge base that holds all these associations for one or more domains. In the case that such an ontology exists, the input features may only match those mentioned in the ontology in the description but not when it comes to their actual content. Whereas designing an ensemble circles around designing features and ML model connections, reasoning-based approaches may in part shift this to designing features and corresponding ontologies as well as concept mapping within the ontologies to allow for combining ML models.

Another approach of “ensembling” may be achieved by way of vertical federated learning, where a general layer (containing all features) is introduced in the global ML model and thereafter subsequent ML models are ensembled in clients which are permitted to have their own architecture. A limitation with this approach is that it only works for neural networks and the ML model needs to be trained as a whole by combining all features. Partial training with subsets will not work as it might end being out-of-sync with the global dense layer.

A different approach addresses overfitting in models, by means of detecting and rejecting data that are redundant (i.e., input features that already exist in the dataset). See e.g., US Patent Publication No. US20060059112A1. This approach describes calculating distances between features using different estimators, extracting statistical significance (p-values) for each distance and if those p-values exceed a certain threshold, rejecting the specific data. In this approach, model stacking (combination) is merely referenced, without details, to combine different model output together to train an aggregated global model.

Various embodiments of the present disclosure may provide solutions to these and other potential problems. In various embodiments, a method for combining ML models is provided. Input features and classes (“classes” are also referred to herein as an “output feature(s)”) are compared with a ML model repository not to increase accuracy of ML models, but to select an appropriate ML model(s) and stack them in such a way so as to match a given input and output description (e.g., an input data type at least partially satisfies input/output in between a composite model). “Input features” is also referred to herein, and is interchangeable, with the terms “input signature” and/or an “input data type” for a ML model or combination of a plurality of ML models. The input data type includes a set of features for use as input for the selected ML model(s). Based on the input data type (and a distribution of input values), the method of various embodiments puts together a ML model (or combination thereof) that at least partially satisfies the input data type. An input data type includes e.g., without limitation, an array form float, float, int, string, ComplexObject, JSONObject etc. In various embodiments, this is performed not by comparing the distance of input feature vectors, but based on the cardinality and type of input features, similarity of input probability distribution and by means of cross artificial intelligence (AI)/ML model training.

Various embodiments of the present disclosure provide a data-driven approach to combining ML models that may overcome the challenges of (i) reasoning-based approaches which have to maintain semantic links between stacked models, and require prior knowledge to do so; and/or (ii) statistical-based approaches (e.g., ensembling) that require that the output of one model in a stack exactly matches the input of another model in the stack or use formulas that do conversions between the input and output.

In various embodiments, given a request from a data providing entity that includes a batch of input features as well as a description of classes (i.e., the desired output), the method selects a ML model(s) from a ML model repository and can combine selected ML models in such a way so that from the initial input features specified, values for classes are produced. Various embodiments include a “feature signature” (also referred to herein as a “first description” or a “second description”) that is a metric that includes similarity of value distributions for features (e.g., Poisson with similar/same λ), and type of features (e.g., integers, 64-bit floating point, etc.).

Various embodiments include a two-phase approach including constructing candidate ML model combinations out of a set of ML models already available in a repository, and using explainable AI (e.g., shapely additive explanations (SHAP), local interpretable model-agnostic explanations (LIME), ELI5, Skater, etc.) as well as model training and execution to choose a candidate ML model combination(s).

In various embodiments, creating combinations of ML models includes use of a feature signature (i.e., a description) for matching an input feature of the input dataset to input features of one or more ML models in the repository, output features of each ML model and the input features of the next in the stack as well as matching output features of a ML model to the output. Contrary to reasoning-based approaches which require prior contextual knowledge in order to do this matching, various embodiments of the present disclosure use statistical methods that do not need such knowledge to exist.

In various embodiments, selecting a ML model combination out of a number of candidate ML model combinations uses SHAP/LIME, etc. to provide feature attributions which in turn can indicate importance of an input feature is carried over to other ML models in the stack. Some embodiments include training the candidate ML model combinations and selecting a combination with highest accuracy.

A potential advantage provided by various embodiments of the present disclosure may include universal or generally applicability of statistical based approaches without requiring additional preexisting knowledge that symbolic approaches, such as reasoning, require. As a consequence, the method of various embodiments may be immediately applied to existing ML model repositories, such as Amazon model marketplace. https://aws.amazon.com/marketplace/b/6297422012?ref=hmpg categories 629742201 2 (accessed Jan. 21, 2021).

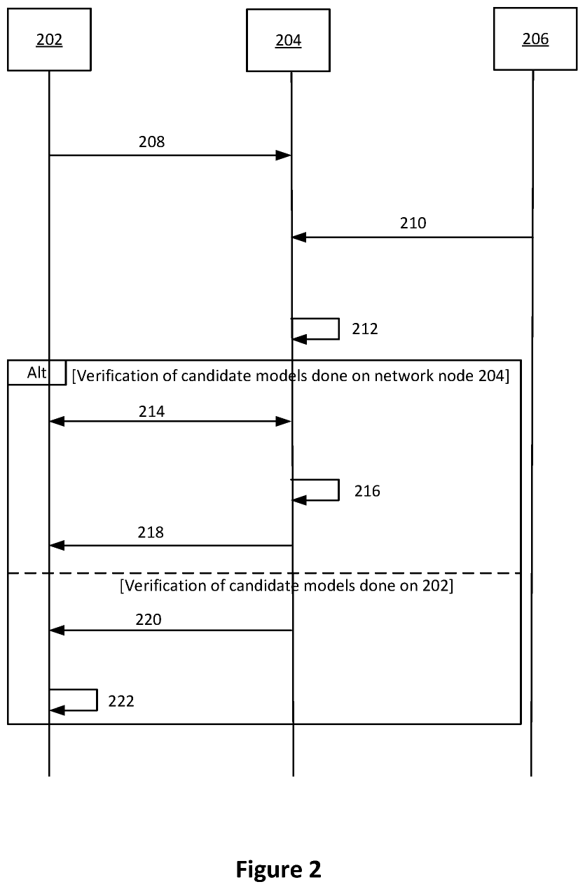

FIG. 2 is a sequence flow illustrating a method for combining ML models in accordance with various embodiments of the present disclosure.

As illustrated in FIG. 2, three entities are included in the sequence flow: data processing entity 202, network node 204, and repository 206. Data processing entity 202 provides an input batch of data. This data includes an ordered list of input features (both type of input and distribution of input values), as well as a description of the output (in terms of a list of type of output features). While embodiments discussed herein are explained in the non-limiting context of using a “list”, the invention is not so limited. Instead, other formats may be used, including without limitation, a table, a matrix, etc. Repository 206 holds ML models that can be used to execute inference over data processing entity 202's input features and provide its requested output. Network node 204 includes a component for ML model stacking which can use data processing entity 202's descriptions and repository 206's ML models to create combinations of ML models, that given data processing entity 202's input description generates the data processing entity 202's specified output.

Data processing entity 202, network node 204, and repository 206 are logical entities and can be physically co-located or can be physically separate in a communication network. In some embodiments for a 3rd generation partnership project (3GPP) based mobile network, data processing entity 202 can be a cell site(s) (radio base station(s)), and repository 206 and network node 204 can be co-located in the mobile operator's core network (e.g., as part of Unified Data Management (UDM) and Network Data Analytics Function (NWDAF) nodes respectively). In another or alternative embodiment, data processing entity 202 can be a router(s), and repository 206 and network node 204 can be a network management system in some local-private or public cloud. While various embodiments are described with reference to a mobile network, the invention is not so limited, and includes any communication network (e.g., a private network, the Internet, a wide area network, etc.)

Still referring to FIG. 2, at 208, data processing entity 202 provides a request including a description of a batch of input data to network node 204, together with the desired output (e.g., in terms of number and type of features). Data processing entity 202 does not know which ML model or combination of ML models from repository 206 should be executed for the input batch. The description of the input batch includes a list (or other format) of input features, which have a value type (e.g., float16, float64, float32, int16, int32, int64, int8, etc.). The same value types apply to the output features. In addition, the description in data processing entity 202's request provides an input distribution of values for the input batch features. The input distribution of values includes the name of the distribution and its parameters (e.g., “Poisson, λ=4”, “geometric, p=0.2”).

An input distribution of values can be identified (e.g., when the input distribution belongs to an existing popular and/or known distribution, for example normal, uniform, exponential, etc.). The input distribution of values can also be characterized (e.g., with a formula and/or parameters when the input distribution does not belong to an existing popular and/or known distribution). In some embodiments, the identification or characterization can be performed with moments (e.g., moments of a function (e.g., an input distribution of values) are quantitative measures related to a shape of the function's graph). In an example embodiment when the input distribution is not well known, a formula can be supplied directly. At 210, network node 204 fetches an updated list (or other format) of ML models from repository 206. The list does not include the ML model(s) data but rather a ML model identifier, input, and class type. Additionally, in some embodiments, when repository 206 knows the probability distribution of the values of the dataset the ML models were trained with, repository 206 reports that as well. In another or alternative embodiment, network node 204 deduces the input distribution with some approximation using a generative adversarial network approach (GAN). In such an approach, two neural networks are competing against each other, with one of them the generator, learning to generate data to fool the other one, the discriminator. In some embodiments, the discriminator is a ML model stored in repository 206 and the generator is a ML model at network node 204.

Once network node 204 is in possession of one or more ML models and their input distribution, at 212 network node 204 executes a ML model combination process (discussed further herein), which compares the description of the input batch from each ML model retrieved from repository 206, with the description of the input batch and output description sent from data processing entity 202. The process converges by returning a set of candidate ML models that match data processing entity 202's input and output feature/class.

Once the candidate ML model list is returned from the process, a number of verification techniques can be applied to find a most likely match. These verification techniques can be performed in isolation or combined and extracted, e.g., an average consensus (discussed further herein). In some embodiments, these verification techniques need access to data processing entity 202's dataset. In some embodiments, the verification techniques can be carried out at the data processing entity 202 as shown in operations 220-222 of FIG. 2. At 220, network node 204 sends the candidate ML model(s) to data processing entity 202. At 222, data processing entity 202 identifies a ML model or a ML model combination that performed best. An access token can be provided to data providing entity 202 to execute the identified ML model or ML model combination with its input via an application interface (API) order. In another or alternative embodiment, the ML model or combination of ML models can be provided to data processing entity 202.

In another or alternative embodiment, the verification techniques on the candidate ML model(s) can be carried out at network node 204 as shown in operation 216 of FIG. 2, in which case network node 204 requests and receives 214 the input dataset values from data processing entity 202. At operation 218, network node 204 sends an identification of a ML model or a ML model combination that performed best. An access token can be provided to data providing entity 202 to execute the identified ML model or ML model combination with its input via an application interface (API) order. In another or alternative embodiment, the ML model or combination of ML models can be returned.

Candidate ML model selection will now be discussed. Pseudocode, entitled “Choosing Candidate Models”, is provided below illustrating an example embodiment of a candidate ML model selection in accordance with various embodiments of the present disclosure. The selection can be executed in network node 204 upon request for a new ML model/ML model combination from data processing entity 202 and upon/after network node 204 retrieving a ML model list from repository 206.

Choosing Candidate Models

```
// Notation: mᵢₙₚᵤₜ is the input provided from data processing entity (DP), f is a feature
// (input feature or output class), (distr, type) is the feature's signature (aka description)
// mₒᵤₜₚᵤₜ is the output description provided from DP
// R is a list of models retrieved from the model repository (MR)
Let mᵢₙₚᵤₜ = [f1ᵢ, ..., fnᵢ] : fxᵢ = (distrxᵢₙₚᵤₜ, typexᵢₙₚᵤₜ) ∀ fxᵢ ∈ mᵢₙₚᵤₜ
Let mₒᵤₜₚᵤₜ = [o₁, ..., oₕ] : o_{z} = typezₒᵤₜₚᵤₜ ∀o_{z} ∈ mₒᵤₜₚᵤₜ
Let R = [m1ᵣₑₚ, ..., mkᵣₑₚ] : mxᵣₑₚ = (fx1ᵣₑₚ, ..., fxyᵣₑₚ, [ox1ᵣₑₚ, oxwᵣₑₚ]] ∀mxᵣₑₚ ∈ R
Let fijᵣₑₚ = (distrijᵣₑₚ, typeijᵣₑₚ)∀fijᵣₑₚ ∈ mxᵣₑₚ
Let oijᵣₑₚ = (typeijᵣₑₚ)∀oijᵣₑₚ ∈ mxᵣₑₚ
Initialize empty array candidate_models = [ ]
//Find single models from R with signature that matches that of mᵢₙₚᵤₜ
for miᵣₑₚ in R do
    // If the number of input features and the number of output features match as well as
    their cardinality
  if (feature_number(miᵣₑₚ) = = feature_number(mᵢₙₚᵤₜ) AND (feature_number(mxᵣₑₚ)
    = = feature_number(miₒᵤₜₚᵤₜ) then
              match = false
    end if
end for
for (oxkᵣₑₚ in miᵣₑₚ) do
    if (fxirep.distrxᵢₙₚᵤₜ ! = mᵢₙₚᵤₜ.fiᵢ.distr) OR ((fxirep.typexᵢₙₚᵤₜ ! = mᵢₙₚᵤₜ.fiᵢ.type)) then
              match = false
    end if
end for
if match == true then
              candidate_models.add(miᵣₑₚ)
              Pop miᵣₑₚ from R
    end if
end for
// Find combinations of models from R with signature that matches mᵢₙₚᵤₜ
Set list_input_features = mᵢₙₚᵤₜ
Set list_classes = mₒᵤₜₚᵤₜ
// For the pseudocode below presence of the following methods is assumed
//featureCount(m1, m2): number of features of lists I1, I2 that match
//note: must be consecutive features that match
// featureIndices(m1, m2): feature indices of I1, that matches features I2
// note: must be consecutive indices that match
Set f_count = list[miᵣₑₚ, featureCount(list_input_features, miᵣₑₚ) )
Sort f_count by descending_order( featureCount(list_input_features, miᵣₑₚ) )
Set model_combinations=[ ] [ ] // List of candidate model combinations
Set new_count = f_count
while new_count has more elements do
    Set temp_combination = [ ] // Will hold a candidate model combination temporarily
    Set list_input_features = minput // Reset list of input features
    while f_count has more elements do
      Get next f_count[i], starting from first
      while list_input_features has more features do
          Get indices = featureIndices(list_input_features, f_count[i].miᵣₑₚ)
          if indices >= 0 then
              Pop list_input_features[indices]
              temp_combination.add(miᵣₑₚ)
            end if
        end while
        if (list_input_feature.size( ) == 0 AND temp_combination.sixe( ) > 0 ) then
            model.combinations.add(mirep) // If model combination covers all input features,
            add to list
        end if
      end while
model_combinations.removeDuplicates( ) // Remove any duplicates from process above
// For the rest of this process assume the following methods
// featureMatch(I1, listoflists): returns true if features in I1 are matched to a list of feature
lists
// recursiveModelMatch(I1, modelList): returns double array of model combinations if
// features in I1 are matched to a combination of models that have as input output from
// model list. Each model combination includes the modelList in the beginning
for model_combination in model_combinations do
    if (featureMatch((moutput),model_combination) AND (model_combination.size > 1)
    then
        candidate_models.add(model_combinations) // Already added single models hence the
      > 1
  else
            GET temp_combinations=recursiveModelMatch((moutput), model_combination)
            for combination in temp_combinations do
              if combination.size > 1 then
                candidate_models.add(combination)
              end if
            end for
      end if
end for
return candidate models
```

Referring to the above example embodiment of pseudocode, given a list of ML models from a repository (e.g., a “reference list”), the process starts by matching individual ML models from the repository reference list to data processing entity 202's input description and output description. Successful matches are removed from the reference list and are stored to a “candidate models” list.

Subsequently, the process looks into whether the input signature (i.e., description) of more than one ML models from the remainder of the reference list match the input feature signature (i.e., description) supplied by data processing entity 202. There can be multiple combinations of ML models that do this. These combinations are stored as “initial_models” temporarily in a buffer.

Further, and for every combination in the “initial_models” list, the process checks whether the output description supplied by data processing entity 202 can be matched by those initial ML models. If there is a direct match, then no horizontal combination is necessary, and those combinations in “initial_models” are stored in the “candidate models” list.

Additionally, and for all other combinations that have not been directly matched to the output in the operation above, the process recursively explores the remainder of the reference list model space to find out which combinations of other models produce the output requested from data processing entity 202. It is possible to parametrize with the depth of recursion, as in theory and given a large enough model space it is possible to result in heavy computation and can have quite a huge depth until the process finds a combination that produces the output.

The process then adds to the candidate models list those combinations that led to an output getting mapped and converges by returning the candidate models list. As per previous, the list may include one or more individual ML models and/or combinations of ML models that match the input feature signature and output class types, provided from data processing entity 202.

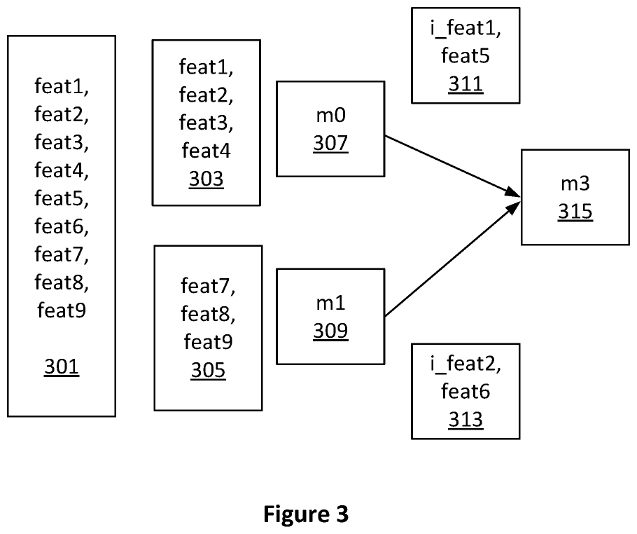

FIG. 3 is a block diagram illustrating an example embodiment of three ML models combined in accordance with various embodiment of the present disclosure. Block 301 includes a first description provided to network node 204 that includes a set of input features from data processing entity 202 (e.g., feat1 . . . feat9). Given the first description in the request, network node 204 fetches an identity of ML models from repository 206 (m0 307 and m1 309), and the input and class type 303, 305 for the identified ML models. Once network node 204 is in possession of the identified ML models (m0 307 and m1 309) and their input distribution 303, 305, network node 204 executes a ML model combination process. The ML combination process compares the description of the input batch 303, 305 from each ML model (m0 307 and m1 309) retrieved from repository 206, with the description 301 of the input batch and output description received from data processing entity 202. The process converges by returning a candidate ML combination model m3 311 that matches data processing entity 202's input and output feature/class 301. Once the identified candidate ML combination model (m3 315) is returned from the process, a verification technique(s) 311, 313 is applied.

Model verification techniques will now be discussed.

In some embodiments of the present disclosure, a candidate list of a ML model or ML models is produced, the list undergoes a process of verification, wherein each candidate is verified against data processing entity 202's input data. The verification uses data processing entity 202's actual dataset, not the description of input and output provided in the initial request. In some embodiments, this can be done at data processing entity 202 (upon/after receiving the candidate list from network node 204). In another or alternative embodiment, this can be done at network node 204. If done at network node 204, data processing entity 202 sends its data to network node 204. If done at data processing entity 202, no data transmission is necessary.

In various embodiments of the present disclosure, three separate verification techniques can be used. The verification techniques can be used in combination (e.g., producing an average “compatibility” score) or in isolation (e.g., depending on the implementation only one or two can be carried out). While the embodiments discussed herein are explained in the non-limiting context of three verification techniques, the invention is not so limited, and other or additional verification techniques may be included.

A first verification technique for incremental model training will now be discussed.

The candidate ML models or ML model combinations may have proper input/output types and input distributions with respect to data provided by data processing entity 202, but they might still be doing poorly mapping input to output. In one example embodiment, accessing relevance of the ML model can use the whole set of data provided by data processing entity 202 as a test set to evaluate accuracy of the matched ML model. If the accuracy is below a predefined threshold, then the ML model is discarded. This example embodiment may be relatively fast and easy to implement; however, it evaluates the ML model(s)'s accuracy out of the box. Such matching works if the matched model has exactly the same semantics and was trained on similar data.

For example, if data processing entity 202 provides images and as ground truth output labels of cars, while matching models is accepting the same format of images but was trained to detect apples or even cars, but of totally different type, then poor accuracy may be expected on the data processing entity 202's data set. Despite that there may be poor accuracy out of the box, the underlying ML model may be well suited to detect cars and if some training of the matched model with subset of data processing entity 202's data set is performed, a sharp improvement of accuracy may be observed.

In some embodiments, repository 206 contains multiple matching ML models or composition ML models. A best suitable alternative can be chosen based on the first technique described above for assessment of model accuracy out of the box or with training.

A second technique for carryover of feature importance using explainable AI techniques is now discussed.

In some embodiments, the second technique may be useful for selecting among multiple ML model combinations. For each combination of ML models in the candidate ML model list, an explainable AI technique may be performed (e.g., SHAP, LIME, ELI5, Skater, etc.) to check if input features carry any importance over the output variable, and whether this importance is propagated through the different layers of ML models. If such importance is carried over among the multiple model layers, then the combined ML model is approved. The importance can be quantified and subsequently compared with that of other ML models. In some embodiments, the ML model where the importance carryover is the greatest is selected.

A third technique using symbolic AI to verify matched models (e.g., ontologies) is now discussed.

In some embodiments, the third technique adds dynamic context into the stack, e.g., in the form of some symbolic representation such as ontologies. If there are multiple explanations that are possible, the relevant ones can be restricted by using the context. In some embodiments of conflicting explanations, some of them can be resolved based on the context. The context can be, e.g., just an explanation by example, counterfactual explanations, or any subset of features that define the present system. In an example embodiment, data processing entity 202 provides a dataset that reads temperature and humidity and decides when to turn on a fire extinguisher. This dataset can be matched against two ML models with the same type of input and binary class, but one of them uses humidity and temperature to actuate fans to cool down, e.g., a computer, while the other actually turns on a water supply. To find out the best model, some metadata on what the output actually means can be compared. For the third technique, data processing entity 202 also provides the metadata of input and output together with statistical descriptions in its initial request.

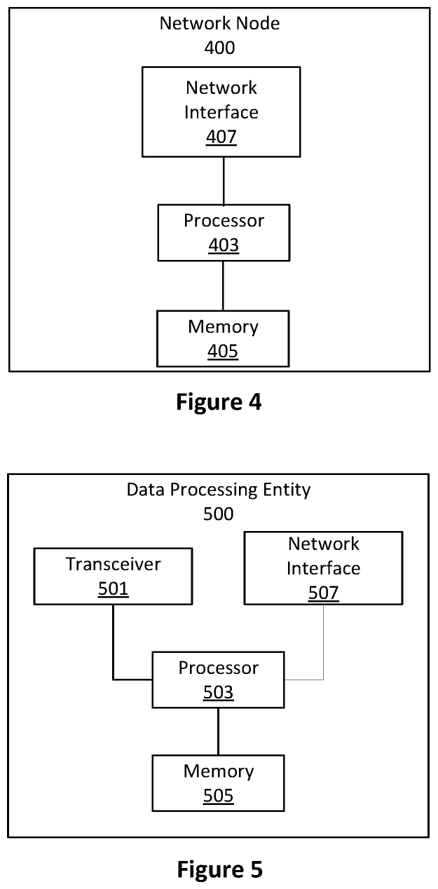

FIG. 4 is a block diagram illustrating a network node 400 (e.g., network node 204) communicatively connected to a data processing entity (e.g., data processing entity 202) and a repository (e.g., repository 206) in a communication network. The network node 400 includes a processor circuit 403 (also referred to as a processor), a memory circuit 405 (also referred to as memory), and a network interface 407 (e.g., wired network interface and/or wireless network interface) configured to communicate with other network nodes, data processing entities, and repositories. The memory 405 stores computer readable program code that when executed by the processor 403 causes the processor 403 to perform operations according to embodiments disclosed herein.

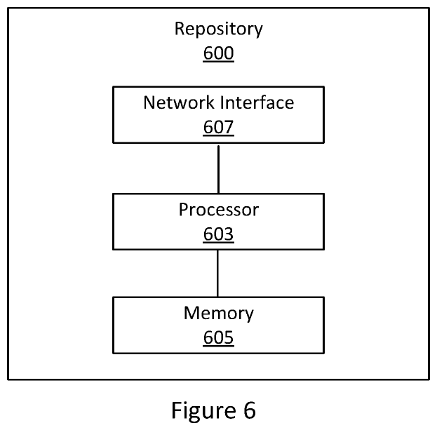

FIG. 5 is a block diagram illustrating a data processing entity 500 (e.g., data processing entity 202) communicatively connected to a network node (e.g., network node 204) and a repository (e.g., repository 206). The data processing entity includes processing circuitry 503, device readable medium 505 (also referred to herein as memory), network interface 507, and transceiver 501. As shown, the data processing entity may include network interface circuitry 507 (also referred to as a network interface) configured to provide communications with other nodes or entities of the communication network. The data processing entity may also include a processing circuitry 503 (also referred to as a processor) coupled to the network interface circuitry, and memory circuitry 505 (also referred to as memory) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the data processing entity may be performed by processing circuitry 503 and/or network interface circuitry 507. For example, processing circuitry 503 may control network interface circuitry 507 to transmit communications through network interface circuitry 507 to one or more network nodes, repositories, etc. and/or to receive communications through network interface circuitry from one or more network nodes, repositories, etc. Moreover, modules may be stored in memory 505, and these modules may provide instructions so that when instructions of a module are executed by processing circuitry 503, processing circuitry 503 performs respective operations according to embodiments disclosed herein.

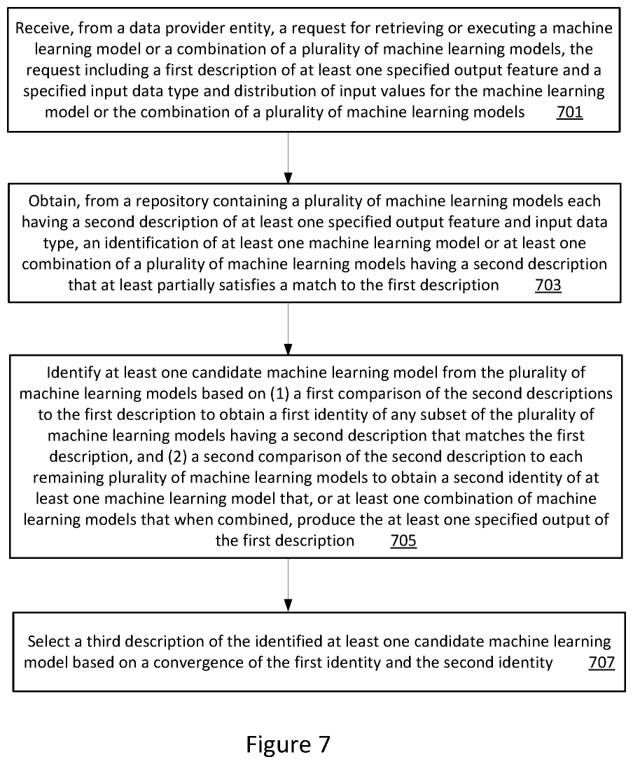

FIG. 6 is a block diagram illustrating a repository 600 (e.g., repository 204) including a repository of ML models. Repository 600 is communicatively connected to a data processing entity (e.g., data processing entity 202) and a network node (e.g., network node 204). The repository 600 includes a processor circuit 603 (also referred to as a processor), a memory circuit 605 (also referred to as memory), and a network interface 607 (e.g., wired network interface and/or wireless network interface) configured to communicate with network nodes, data processing entities, and repositories. The memory 605 stores computer readable program code that when executed by the processor 603 causes the processor 603 to perform operations according to embodiments disclosed herein. Repository 600 may be a database.

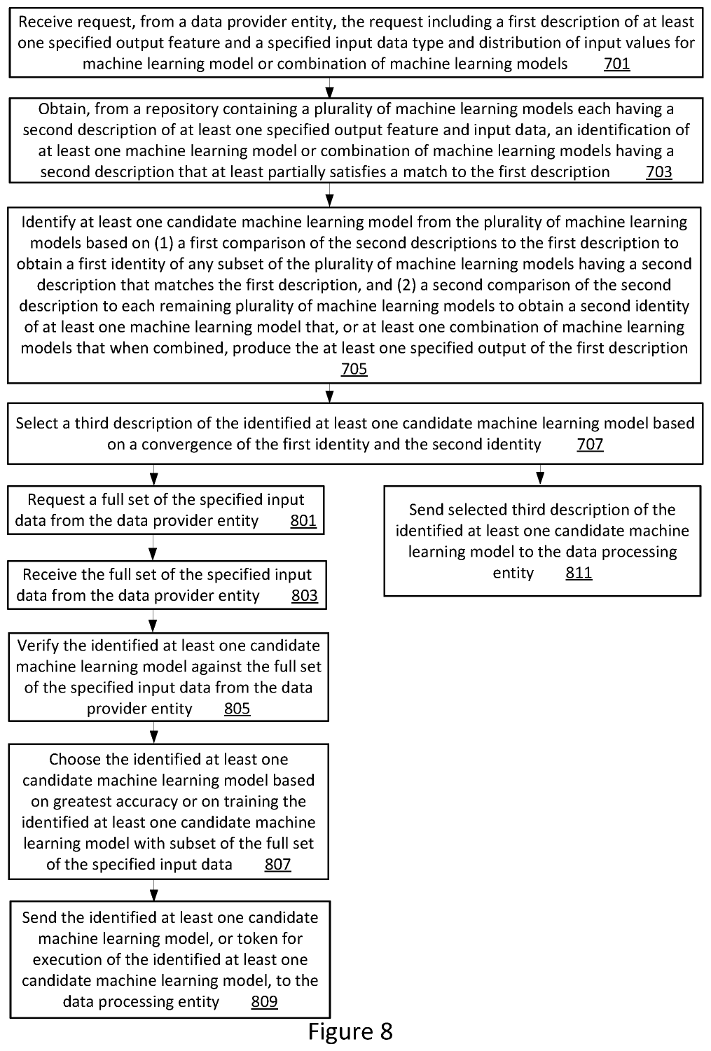

Now that the operations of the various components have been described, operations specific to a network node 204 (implemented using the structure of the block diagram of FIG. 4) will now be discussed with reference to the flow charts of FIGS. 7 and 8 according to various embodiments of the present disclosure. As shown, the memory circuitry 405 of network node 400 may include computer readable program code that when executed by the processing circuitry 403 causes the processing circuitry 403 to perform operations respective operations of the flow chart of FIGS. 7 and 8 according to embodiments disclosed herein.

Referring first to FIG. 7, a computer-implemented method performed by a network node (e.g., 204, 400) in a communication network is provided. The method includes receiving (701), from a data provider entity, a request for retrieving or executing a machine learning model or a combination of a plurality of machine learning models. The request includes a first description of at least one specified output feature and a specified input data type and distribution of input values for the machine learning model or the combination of a plurality of machine learning models. The method further includes obtaining (703), from a repository containing a plurality of machine learning models each having a second description of at least one specified output feature and input data type, an identification of at least one machine learning model or at least one combination of a plurality of machine learning models having a second description that at least partially satisfies a match to the first description. The method further includes identifying (705) at least one candidate machine learning model from the plurality of machine learning models based on (1) a first comparison of the second description of each of the plurality of machine learning models to the first description to obtain a first identity of any subset of the plurality of machine learning models having a second description that matches the first description, and (2) a second comparison of the second description to each of the remaining of the plurality of machine learning models, other than the subset, to obtain a second identity of at least one machine learning model that, or at least one combination of machine learning models from the remaining machine learning models that when combined, produce the at least one specified output of the first description. The method further includes selecting (707) a third description of the identified at least one candidate machine learning model based on a convergence of the first identity and the second identity.

Referring now to FIG. 8, in some embodiments, the method further includes requesting (801) a full set of the specified input data from the data provider entity. The method further includes receiving (803) the full set of the specified input data from the data provider entity. The method further includes verifying (805) the identified at least one candidate machine learning model against the full set of the specified input data from the data provider entity.

In some embodiments, the first description includes a plurality of specified input data types, the distribution of input values for the plurality of specified input data types, and at least one output feature having the specified input data type.

In some embodiments, the distribution of input values includes a name of the distribution and at least one parameter for the distribution.

In some embodiments, the input distribution is an unknown distribution, and the input distribution is characterized using moments.

In some embodiments, the identification in the obtaining (703) includes an identifier for the identified at least one candidate machine learning model, inputs to the identified at least candidate one machine learning model, and an output feature of the identified at least one candidate machine learning model.

In some embodiments, the verifying (805) includes use of a partial or the full set of the specified input data as a test set of data for an evaluation of accuracy of the identified at least one candidate machine learning model. The specified input data includes an input vector, and the test set of data includes a set of tuples of the input features and the corresponding output features.

In some embodiments, subsequent to the verifying (805), the method further includes choosing (807) the identified at least one candidate machine learning model based on the greatest accuracy or on training the identified at least one candidate machine learning model with a subset of the full set of the specified input data. The method further includes sending (809) the identified at least one candidate machine learning model, or a token for execution of the identified at least one candidate machine learning model, to the data processing entity.

In some embodiments, the verifying (805) includes, for the identified at least one candidate machine learning model, obtaining an output of analysis from a model interpretation method to check whether the input features carry an importance over the output feature, and whether the importance is propagated through different layers of the identified at least one candidate machine learning model. The method further includes, when the importance is propagated, approval of the identified at least one candidate machine learning model.

In some embodiments, the request further includes metadata, and the verifying (805) includes use of symbolic expression to match context from the metadata with metadata of the identified at least one candidate machine learning model. In some embodiments, the context includes a symbolic representation.

In some embodiments, the method further includes sending (811) the selected third description of the identified at least one candidate machine learning model to the data processing entity.

In some embodiments, the network node is located at one of: physically co-located with at least one of the data processing entity and the repository; physically located separate from at least one of the data processing entity and the repository; a core network node of a mobile network; a local-private cloud; and a public cloud.

In some embodiments, the data processing entity is located at one of: physically co-located with at least one of the network node and the repository; physically located separate from at least one of the network node and the repository; a cell site in a mobile network; and a router.

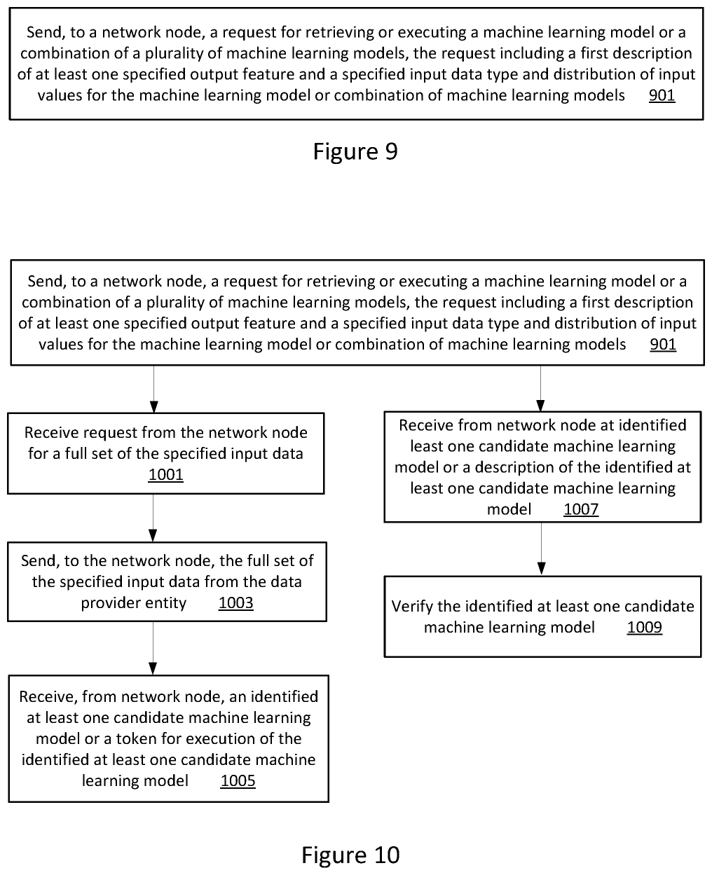

Operations of a data processing entity (implemented using the structure of FIG. 5) will now be discussed with reference to the flow chart of FIGS. 9 and 10 according to embodiments of the present disclosure.

Referring first to FIG. 9, a computer-implemented method performed by a data processing entity (202, 500) in a communication network is provided. The method includes sending (901), to a network node, a request for retrieving or executing a machine learning model or a combination of a plurality of machine learning models. The request includes a first description of at least one specified output feature and a specified input data type and distribution of input values for the machine learning model or the combination of a plurality of machine learning models.

In some embodiments, the method further includes receiving (1001) a request from the network node for a full set of the specified input data. The method further includes sending (1003), to the network node, the full set of the specified input data from the data provider entity. The method further includes receiving (1005), from the network node, an identified at least one candidate machine learning model or a token for execution of the identified at least one candidate machine learning model.

In some embodiments, the method further includes, responsive to the request, receiving (1007) from the network node the identified at least one candidate machine learning model or a description of the identified at least one candidate machine learning model. The method further includes verifying (1009) the identified at least one candidate machine learning model.

In some embodiments, the verifying (1009) includes, for the identified at least one candidate machine learning model, obtaining an output of analysis from a model interpretation method to check whether the specified input data type and distribution of input values carry an importance over the output feature, and whether the importance is propagated through different layers of the identified at least one combination of machine learning models. The method further includes, when the importance is propagated, approval of the identified at least one combination of machine learning models.

In some embodiments, the request further includes metadata, and the verifying (1009) includes use of symbolic artificial intelligence to match context from the metadata with the identified at least one candidate machine learning model.

In some embodiments, the context includes a symbolic representation.

Various operations from the flow chart of FIG. 8 may be optional with respect to some embodiments of a method performed by a network node. For example, operations of blocks 801-811 of FIG. 8 may be optional. Additionally, various operations from the flow chart of FIG. 10 may be optional with respect to some embodiments of a method performed by a data processing entity. For example, operations of blocks 1001-1009 of FIG. 10 may be optional.

Although network node 400, data processing entity 500, and repository 600 are illustrated in the example block diagrams of FIGS. 4-6 an each may represent a device that includes the illustrated combination of hardware components, other embodiments may comprise network nodes, data processing entities, and repositories with different combinations of components. It is to be understood that each of a network node, a data processing entity, and a repository comprise any suitable combination of hardware and/or software needed to perform the tasks, features, functions and methods disclosed herein. Moreover, while the components of each of a network node, a data processing entity, and a repository are depicted as single boxes located within a larger box, or nested within multiple boxes, in practice, each device may comprise multiple different physical components that make up a single illustrated component (e.g., a memory may comprise multiple separate hard drives as well as multiple RAM modules).

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

References are identified below.
1. https://aws.amazon.com/marketplace/b/6297422012?ref=hmpg categories 629 7422012 (accessed Jan. 21, 2021)
2. US20060059112A1—Machine learning with robust estimation, bayesian classification and model stacking

1. A computer-implemented method performed by a network node in a communication network, the method comprising:
receiving, from a data provider entity, a request for retrieving or executing a machine learning model or a combination of a plurality of machine learning models, the request including a first description of at least one specified output feature and a specified input data type and distribution of input values for the machine learning model or the combination of a plurality of machine learning models;
obtaining, from a repository containing a plurality of machine learning models each having a second description of at least one specified output feature and input data type, an identification of at least one machine learning model or at least one combination of a plurality of machine learning models having a second description that at least partially satisfies a match to the first description;
identifying at least one candidate machine learning model from the plurality of machine learning models based on (1) a first comparison of the second description of each of the plurality of machine learning models to the first description to obtain a first identity of any subset of the plurality of machine learning models having a second description that matches the first description, and (2) a second comparison of the second description to each of the remaining of the plurality of machine learning models, other than the subset, to obtain a second identity of at least one machine learning model that, or one at least one combination of machine learning models from the remaining machine learning models that when combined, produce the at least one specified output of the first description; and
selecting a third description of the identified at least one candidate machine learning model based on a convergence of the first identity and the second identity.

2. The method of claim 1, further comprising:
requesting a full set of the specified input data from the data provider entity;
receiving the full set of the specified input data from the data provider entity; and
verifying the identified at least one candidate machine learning model against the full set of the specified input data from the data provider entity.

3. The method of claim 1, wherein the first description comprises a plurality of specified input data types, the distribution of input values for the plurality of specified input data types, and at least one output feature having the specified input data type.

4. The method of claim 3, wherein the distribution of input values comprises a name of the distribution and at least one parameter for the distribution.

5. The method of claim 3, wherein the input distribution is an unknown distribution, and the input distribution is characterized using moments.

6. The method of claim 1, wherein the identification in the obtaining comprises an identifier for the identified at least one candidate machine learning model, inputs to the identified at least one candidate machine learning model, and an output feature of the identified at least one candidate machine learning model.

7. The method of claim 2, wherein the verifying comprises use of a partial or the full set of the specified input data as a test set of data for an evaluation of accuracy of the identified at least one candidate machine learning model, wherein the specified input data comprises an input vector and wherein the test set of data comprises a set of tuples of the input features and the corresponding output features.

8. The method of claim 7, subsequent to the verifying, further comprising:
choosing the identified at least one candidate machine learning model based on the greatest accuracy or on training the identified at least one candidate machine learning model with a subset of the full set of the specified input data; and
sending the identified at least one candidate machine learning model, or a token for execution of the identified at least one candidate machine learning model, to the data processing entity.

9. The method of claim 2, wherein the verifying comprises, for the identified at least one candidate machine learning model,
obtaining an output of analysis from a model interpretation method to check whether the input features carry an importance over the output feature, and whether the importance is propagated through different layers of the identified at least one candidate machine learning models, and
when the importance is propagated, approval of the identified at least one candidate machine learning model.

10. The method of claim 2, wherein the request further comprises metadata, and wherein the verifying comprises use of symbolic expression to match context from the metadata with metadata of the identified at least one candidate machine learning model.

11. The method of claim 10, wherein the context comprises a symbolic representation.

12. The method of claim 1, further comprising: sending the selected third description of the identified at least one candidate machine learning model to the data processing entity.

13. The method of claim 1, wherein the network node is located at one of: physically co-located with at least one of the data processing entity and the repository; physically located separate from at least one of the data processing entity and the repository; a core network node of a mobile network; a local-private cloud; and a public cloud.

14. The method of claim 1, wherein the data processing entity is located at one of: physically co-located with at least one of the network node and the repository; physically located separate from at least one of the network node and the repository; a cell site in a mobile network; and a router.

15. A network node in a communication network, the network node comprising:
at least one processor;
at least one memory connected to the at least one processor and storing program code that is executed by the at least one processor to perform operations comprising:
receive, from a data provider entity, a request for retrieving or executing a machine learning model or a combination of a plurality of machine learning models, the request including a first description of at least one specified output feature and a specified input data type and distribution of input values for the requested machine learning model or the combination of a plurality of machine learning models;
obtain, from a repository containing a plurality of machine learning models each having a second description of at least one specified output feature and input data type, an identification of at least one machine learning model or at least one combination of a plurality of machine learning models having a second description that at least partially satisfies a match to the first description; identify at least one candidate machine learning model from the plurality of machine learning models based on (1) a first comparison of the second description of each of the plurality of machine learning models to the first description to obtain a first identity of any subset of the plurality of machine learning models having a second description that matches the first description, and (2) a second comparison of the second description to each of the remaining of the plurality of machine learning models, other than the subset, to obtain a second identity of at least one machine learning model that, or at least one combination of machine learning models from the remaining machine learning models that when combined, produce the at least one specified output of the first description; and
select a third description of the identified at least one candidate machine learning model based on a convergence of the first identity and the second identity.

16.-28. (canceled)

29. A data processing entity in a communication network, the data processing entity comprising:
at least one processor;
at least one memory connected to the at least one processor and storing program code that is executed by the at least one processor to perform operations comprising:
send, to a network node, a request for retrieving or executing a machine learning model or a combination of a plurality of machine learning models, the request including a first description of at least one specified output feature and a specified input data type and distribution of input values for the machine learning model or the combination of a plurality of machine learning models.

30. The data processing entity of claim 29, wherein the operations further comprise to:
receive a request from the network node for a full set of specified input data;
send, to the network node, the full set of the specified input data from a data provider entity; and
receive, from the network node, an identified at least one candidate machine learning model or a token for execution of the identified at least one candidate machine learning model.

31.-36. (canceled)

37. The data processing entity of claim 29, wherein the operations further comprise to:
responsive to the request, receive from the network node the identified at least one candidate machine learning model or a description of the identified at least one candidate machine learning model; and
verify the identified at least one candidate machine learning model.

38. The data processing entity of claim 29, wherein the operation to verify comprises to:
obtain an output of analysis from a model interpretation method to check whether the specified input data type and distribution of input values carry an importance over the output feature, and whether the importance is propagated through different layers of the identified at least one combination of machine learning models, and
when the importance is propagated, approve the identified at least one combination of machine learning models.
